(19) United States
(12) Patent Application Publication
(10) Pub. No.: US 2026/0219024 A1
(43) Pub. Date: Jul. 30, 2026

(54) THREE-DIMENSIONAL SURVEY DEVICE, THREE-DIMENSIONAL SURVEY DEVICE DRIVING METHOD, AND THREE-DIMENSIONAL SURVEY DEVICE DRIVING PROGRAM

(71) Applicant: Topcon Corporation, Itabashi-ku, Tokyo (JP)

(72) Inventors: Masae MATSUMOTO, Itabashi-ku, Tokyo (JP); Jun ABE, Itabashi-ku, Tokyo (JP); Naoki SHOJI, Itabashi-ku, Tokyo (JP)

(73) Assignee: Topcon Corporation, Itabashi-ku, Tokyo (JP)

(21) Appl. No.: 19/110,324

(22) PCT Filed: Sep. 11, 2023
(86) PCT No.: PCT/JP2023/033104

§ 371 Date: Mar. 10, 2025

(30) Foreign Application Priority Data
Sep. 12, 2022 (JP) 2022-144694

(51) Int. Cl. G01B 7/30; G01C 15/00

(52) U.S. Cl. CPC G01B 7/30; G01C 15/00

(57) ABSTRACT

A three-dimensional survey device, method, and program suppress an operating time and save power of a battery. The device includes a motor that rotates a rotation target, a rotary encoder that detects a rotation angle of the rotation target, a computation unit that calculates, as an initial phase, a phase relationship between phases of the motor at a zero position of the rotary encoder, and a storage unit that stores the initial phase as a driving parameter. The computation unit causes the storage unit to store the driving parameter in advance, drives the motor by open loop control during an initial operation after power-on, applies the driving parameter stored in the storage unit as a phase angle upon detecting the zero position of the rotary encoder, and then drives the motor by closed loop control that uses a value of the rotary encoder.

### TECHNICAL FIELD

The present invention relates to a three-dimensional survey device, a three-dimensional survey device driving method, and a three-dimensional survey device driving program that acquire three-dimensional data of a measurement target.

### BACKGROUND ART

PTL 1 discloses a survey device that includes an inclination detection device. The survey device described in PTL 1 includes a motor that rotates a rotation target such as a frame or an inclination detection unit about an axial center, and an encoder that detects a rotation angle of the rotation target. As, for example, the motor of the survey device as described in PTL 1, a 3-phase brushless motor that does not include a hall sensor is used in some cases. In this case, during an initial operation after the survey device is powered on, the survey device needs to check and store initial phases of the phases of the motor by executing an oscillation operation of the motor, and control the motor based on the stored initial phases.

However, when the three-dimensional survey device executes an operation of checking and storing the initial phases of the phases of the motor during the initial operation every time, for example, an operator moves the three-dimensional survey device and changes a survey spot, there is a room for improvement in that an operating time of the three-dimensional survey device and an operating time of the operator become long. By contrast with this, there is also one measure of keeping the three-dimensional survey device powered on when, for example, the operator moves the three-dimensional survey device and changes the survey spot. However, if this measure is taken, power consumption of the battery of the three-dimensional device increases, and there is a room for improvement in saving of the power consumption.

### CITATION LIST

### Patent Literature

[PTL 1] Japanese Patent Application Publication No. 2021-63761

### SUMMARY OF INVENTION

### Technical Problem

The present invention has been made with the above situation in view, and an object of the present invention is to provide a three-dimensional survey device, a three-dimensional survey device driving method, and a three-dimensional survey device driving program that can suppress an operating time and save power consumption of a battery.

### Solution to Problem

A first aspect of the present invention is a three-dimensional survey device that acquires three-dimensional data of a measurement target, and that includes: a motor that rotates a rotation target about an axial center; a rotary encoder that detects a rotation angle of the rotation target; a computation unit that calculates as an initial phase a phase relationship of a phase of the motor at a zero position of the rotary encoder; and a storage unit that stores the initial phase calculated by the computation unit as a driving parameter. The computation unit causes the storage unit to store the driving parameter in advance, drives the motor by open loop control during an initial operation after power-on, applies the driving parameter stored in the storage unit as a phase angle upon detecting the zero position of the rotary encoder, and then drives the motor by closed loop control that uses a value of the rotary encoder.

According to the first aspect of the present invention, the computation unit calculates as the initial phase the phase relationship between the phases of the motor at the zero position of the rotary encoder, and causes the storage unit to store the calculated initial phase as the driving parameter in advance. Furthermore, the computation unit drives the motor by open loop control during the initial operation after power-on, and applies the driving parameter stored in the storage unit as the phase angle upon detecting the zero position of the rotary encoder. Thus, the computation unit does not check the initial phases of the phases of the motor by executing an oscillation operation of the motor by closed loop control during the initial operation after power-on. Furthermore, the computation unit applies the driving parameter stored in the storage unit as the phase angle upon detecting the zero position of the rotary encoder, and then drives the motor by closed loop control that uses the value of the rotary encoder. Consequently, the three-dimensional survey device according to the first aspect of the present invention does not need to perform the oscillation operation of the motor during the initial operation after power-on, so that it is possible to reduce a time taken until the zero position of the rotary encoder is detected, and suppress an operating time. Furthermore, for example, an operator does not need to keep the three-dimensional survey device powered on when moving the three-dimensional survey device and changing a survey spot, and the three-dimensional survey device according to the first aspect of the present invention can suppress the operating time, so that it is possible to save power consumption of a battery and extend an operable time.

A second aspect of the present invention is the three-dimensional survey device in which the computation unit calculates the initial phase at each pole of the motor a plurality of times, and causes the storage unit to store an average value of a plurality of the initial phases as the driving parameter in the first aspect of the present invention.

According to the second aspect of the present invention, the computation unit can suppress variations of the initial phases due to an influence of the poles of the motor when calculating the initial phases, and cause the storage unit to store a more stable value as the driving parameter. Consequently, the three-dimensional survey device according to the second aspect of the present invention can more stably drive the motor.

A third aspect of the present invention is a three-dimensional survey device driving method that acquires three-dimensional data of a measurement target, and that includes: a first step of calculating as an initial phase a phase relationship of a phase of the motor at a zero position of a rotary encoder that detects a rotation angle of a rotation target; a second step of storing the initial phase calculated in the first step as a driving parameter in a storage unit in advance; a third step of driving the motor by open loop control during an initial operation after power-on, and applying the driving parameter stored in the storage unit as a phase angle upon detecting the zero position of the rotary encoder; and a fourth step of driving the motor by closed loop control that uses a value of the rotary encoder.

According to the third aspect of the present invention, in the first step, the phase relationship between the phases of the motor at the zero position of the rotary encoder is calculated as the initial phases, and, in the second step, the storage unit is caused to store the initial phases calculated in the first step as the driving parameters in advance. Furthermore, in the third step, the motor is driven by open loop control during the initial operation after power-on, and the driving parameters stored in the storage unit are applied as the phase angles when the zero position of the rotary encoder is detected. Thus, in the third step, the initial phases of the phases of the motor are not checked by executing an oscillation operation of the motor by closed loop control during the initial operation after power-on. Furthermore, in the fourth step, the motor is driven by closed loop control that uses the value of the rotary encoder. Consequently, the three-dimensional survey device driving method according to the third aspect of the present invention does not need to perform the oscillation operation of the motor during the initial operation after power-on, so that it is possible to reduce a time taken until the zero position of the rotary encoder is detected, and suppress an operating time. Furthermore, for example, the operator does not need to keep the three-dimensional survey device powered on when moving the three-dimensional survey device and changing a survey spot, and the three-dimensional survey device driving method according to the third aspect of the present invention can suppress the operating time, so that it is possible to save power consumption of the battery and extend the operable time.

A fourth aspect of the present invention is a three-dimensional survey device driving program that is executed by a computer of a three-dimensional survey device that acquires three-dimensional data of a measurement target, and causes the computer to execute: a first step of calculating as an initial phase a phase relationship of a phase of the motor at a zero position of a rotary encoder that detects a rotation angle of a rotation target; a second step of storing the initial phase calculated in the first step as a driving parameter in a storage unit in advance; a third step of driving the motor by open loop control during an initial operation after power-on, and applying the driving parameter stored in the storage unit as a phase angle upon detecting the zero position of the rotary encoder; and a fourth step of driving the motor by closed loop control that uses a value of the rotary encoder.

According to the fourth aspect of the present invention, in the first step, the phase relationship between the phases of the motor at the zero position of the rotary encoder is calculated as the initial phases, and, in the second step, the storage unit is caused to store the initial phases calculated in the first step as the driving parameters in advance. Furthermore, in the third step, the motor is driven by open loop control during the initial operation after power-on, and the driving parameters stored in the storage unit are applied as the phase angles when the zero position of the rotary encoder is detected. Thus, in the third step, the initial phases of the phases of the motor are not checked by executing an oscillation operation of the motor by closed loop control during the initial operation after power-on. Furthermore, in the fourth step, the motor is driven by closed loop control that uses the value of the rotary encoder. Consequently, the three-dimensional survey device driving program according to the fourth aspect of the present invention does not need to perform the oscillation operation of the motor during the initial operation after power-on, so that it is possible to reduce a time taken until the zero position of the rotary encoder is detected, and suppress an operating time. Furthermore, for example, the operator does not need to keep the three-dimensional survey powered on when moving the three-dimensional survey device and changing a survey spot, and the three-dimensional survey device driving program according to the fourth aspect of the present invention can suppress the operating time, so that it is possible to save power consumption of the battery and extend the operable time.

### Advantageous Effects of Invention

The present invention can provide a three-dimensional survey device, a three-dimensional survey device driving method, and a three-dimensional survey device driving program that can suppress an operating time and save power consumption of a battery.

### BRIEF DESCRIPTION OF DRAWINGS

FIG. 1 is a block diagram for mainly describing a structure system of a three-dimensional survey device according to an embodiment of the present invention.

FIG. 2 is a block diagram for mainly describing a control system of the three-dimensional survey device according to the present embodiment.

FIG. 3 is a flowchart illustrating an advance operation of the three-dimensional survey device according to the present embodiment.

FIG. 4 is a flowchart illustrating an initial operation after the three-dimensional survey device according to the present embodiment is powered on.

FIG. 5 is a graph illustrating an example of a measurement result of initial phases according to the present embodiment.

### DESCRIPTION OF EMBODIMENTS

Hereinafter, an embodiment of the present invention will be described with reference to the drawings.

Note that, although the embodiment described below is a suitable specific example of the present invention, and therefore various technically preferable limitations are added thereto, the scope of the present invention is not limited to this embodiment unless it is described in the following description that a particular limitation is added to the present invention. Furthermore, the same components in each drawing will be assigned the same reference numerals, and detailed description thereof will be omitted as appropriate.

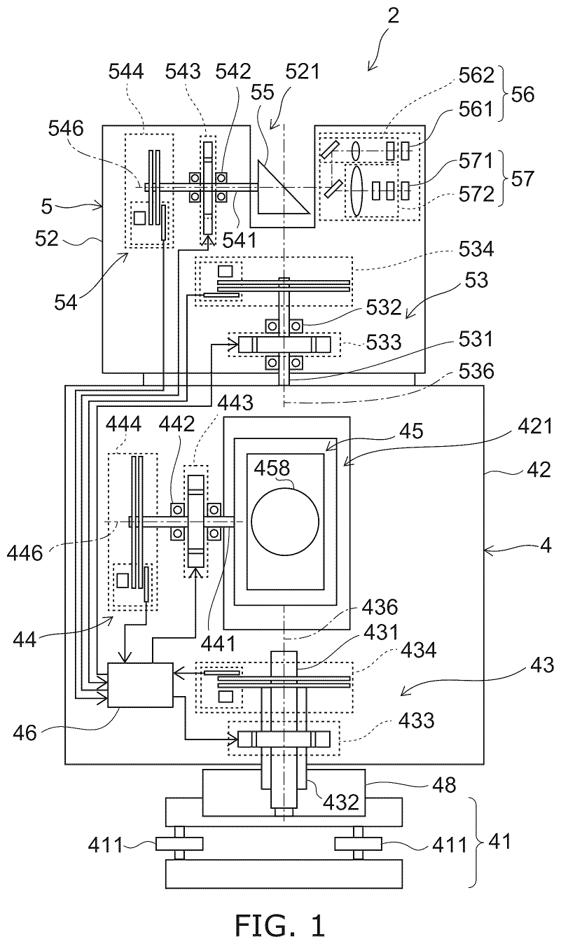

FIG. 1 is a block diagram mainly illustrating a structure system of a three-dimensional survey device according to the embodiment of the present invention.

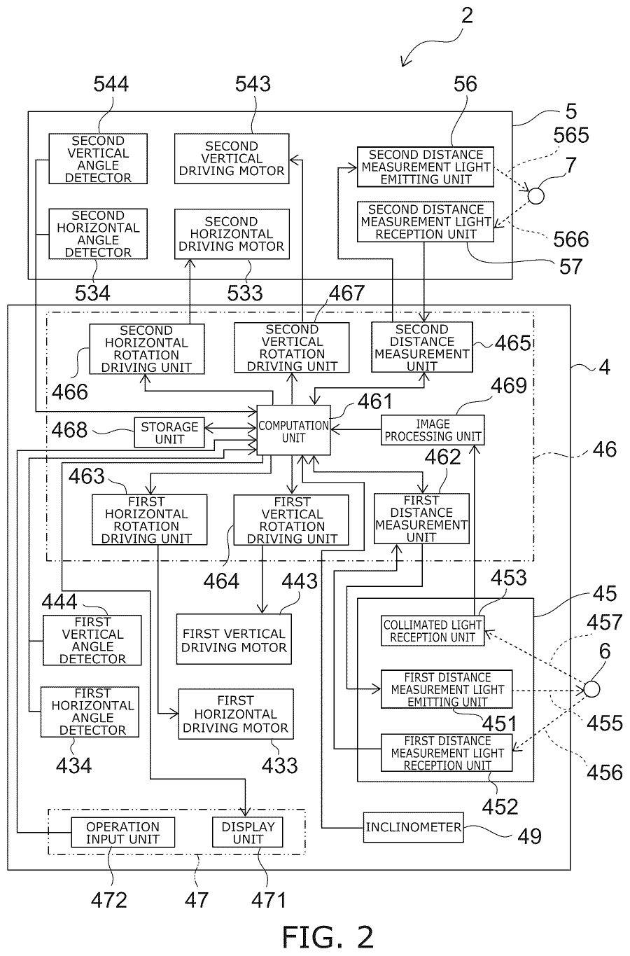

FIG. 2 is a block diagram for mainly describing a control system of the three-dimensional survey device according to the present embodiment.

As illustrated in FIGS. 1 and 2, a three-dimensional survey device 2 according to the present embodiment includes a collimation distance measurement unit 4 and a scanner unit 5, and acquires three-dimensional data of a measurement target such as a structure. Note that the three-dimensional survey device 2 illustrated in FIGS. 1 and 2 is an example, and the three-dimensional survey device 2 according to the present embodiment may not necessarily include both of the collimation distance measurement unit 4 and the scanner unit 5. That is, the three-dimensional survey device 2 according to the present embodiment may be the collimation distance measurement unit 4 called, for example, a total station, and a device that performs distance measurement and angle measurement. Alternatively, the three-dimensional survey device 2 according to the present embodiment may be the scanner unit 5, and a device that performs distance measurement and angle measurement and acquires point cloud data. The description of the present embodiment cites an example of a case where the three-dimensional survey device 2 includes both of the collimation distance measurement unit 4 and the scanner unit 5.

The collimation distance measurement unit 4 according to the present embodiment includes a leveling part 41, a first bracket part 42, a first horizontal rotation part 43, a first vertical rotation part 44, a telescope part 45, a control computation unit 46, an operation display unit 47, a base part 48, and an inclinometer 49. The collimation distance measurement unit 4 has an automatic tracking function of automatically searching for a target for measurement 6 (see FIG. 2).

The control computation unit 46 includes a computation unit 461, a first distance measurement unit 462, a first horizontal rotation driving unit 463, a first vertical rotation driving unit 464, a second distance measurement unit 465, a second horizontal rotation driving unit 466, a second vertical rotation driving unit 467, a storage unit 468, and an image processing unit 469. The computation unit 461 is, for example, a Central Processing Unit (CPU), and activates a program, performs signal control processing, performs computation, and executes driving control of, for example, a display unit 471 of the operation display unit 47 based on a signal (instruction) transmitted from an operation input unit 472 of the operation display unit 47. That is, the computation unit 461 controls the entire three-dimensional survey device 2, and causes the display unit 471 to display measurement conditions, a measurement result (a distance measurement result and an angle measurement result), a result of image processing (an image of a collimation range), and the like.

The first distance measurement unit 462, the first horizontal rotation driving unit 463, the first vertical rotation driving unit 464, the second distance measurement unit 465, the second horizontal rotation driving unit 466, the second vertical rotation driving unit 467, and the image processing unit 469 are implemented when the computation unit 461 executes the program saved (stored) in the storage unit 468. Note that the first distance measurement unit 462, the first horizontal rotation driving unit 463, the first vertical rotation driving unit 464, the second distance measurement unit 465, the second horizontal rotation driving unit 466, the second vertical rotation driving unit 467, and the image processing unit 469 may be implemented as hardware, or may be implemented as a combination of hardware and software.

The storage unit 468 stores, for example, a sequence program for measurement, an image processing program for image processing, a computation program, and the like. Furthermore, the storage unit 468 stores driving parameters to be described later. Details of the driving parameters will be described later. An example of the storage unit 468 is a semiconductor memory built in the three-dimensional survey device 2. Alternatively, examples of the storage unit 468 are various storage media such as Compact Discs (CDs), Digital Versatile Discs (DVDs), Random Access Memories (RAMs), Read Only Memories (ROMs), hard disks, and memory cards that can be connected to the three-dimensional survey device 2.

The program executed by a computer including the control computation unit 46 is an example of a “three-dimensional survey device driving program” according to the present invention. The “computer” described herein is not limited to a personal computer, also includes a computation processing device, a microcomputer, and the like included in an information processing device, and is a generic term of a device and an apparatus that can implement the functions of the present invention by the program.

The leveling part 41 is a part that is attached to a tripod (not illustrated), and includes, for example, three adjustment screws 411. The leveling part 41 performs leveling by adjusting the adjustment screws 411 such that an inclination sensor (not illustrated) provided to the first bracket part 42 detects a horizontal state at, for example, a known point at which the target for measurement 6 is installed. That is, the first bracket part 42 is maintained horizontally by being leveled by the adjustment screws 411 at, for example, the known point at which the target for measurement 6 is installed.

The first horizontal rotation part 43 includes a first horizontal rotary shaft 431, a bearing 432, a first horizontal driving motor 433, and a first horizontal angle detector 434. The first horizontal driving motor 433 is an example of a “motor” according to the present invention, and is, for example, a 3-phase brushless motor that does not include a hall sensor. The first horizontal angle detector 434 is an example of a “rotary encoder” according to the present invention, and is, for example, a rotary encoder of incremental type. The first horizontal rotary shaft 431 includes a first vertical axial center 436 that vertically extends, and is rotatably supported by the base part 48 with the bearing 432 interposed therebetween. The first bracket part 42 is supported by the first horizontal rotary shaft 431, and is rotated integrally with the first horizontal rotary shaft 431 in the horizontal direction about the first vertical axial center 436 by a driving force transmitted from the first horizontal driving motor 433. The first bracket part 42 is an example of a “rotation target” according to the present invention.

A rotation angle of the first horizontal rotary shaft 431 (i.e., a rotation angle of the first bracket part 42) with respect to the base part 48 is detected by the first horizontal angle detector 434. A detection result of the first horizontal angle detector 434 is input to the computation unit 461. Driving of the first horizontal driving motor 433 is controlled by the first horizontal rotation driving unit 463 based on the detection result of the first horizontal angle detector 434.

The first vertical rotation part 44 includes a first vertical rotary shaft 441, a bearing 442, a first vertical driving motor 443, and a first vertical angle detector 444. The first vertical driving motor 443 is an example of the “motor” according to the present invention, and is, for example, the 3-phase brushless motor that does not include the hall sensor. The first vertical angle detector 444 is an example of the “rotary encoder” according to the present invention, and is, for example, the rotary encoder of incremental type. The first vertical rotary shaft 441 includes a first horizontal axial center 446 that horizontally extends, and is rotatably supported by the first bracket part 42 with the bearing 442 interposed therebetween. The one end part of the first vertical rotary shaft 441 protrudes in a gap part 421 of the first bracket part 42. The telescope part 45 is supported at the one end part of the first vertical rotary shaft 441 that protrudes in the gap part 421 of the first bracket part 42, and is rotated integrally with the first vertical rotary shaft 441 in a vertical direction about the first horizontal axial center 446 by a driving force transmitted from the first vertical driving motor 443. The telescope part 45 is an example of the “rotation target” according to the present invention.

The first vertical angle detector 444 is provided at the other end part of the first vertical rotary shaft 441. A rotation angle of the first vertical rotary shaft 441 (i.e., a rotation angle of the telescope part 45) with respect to the first bracket part 42 is detected by the first vertical angle detector 444. A detection result of the first vertical angle detector 444 is input to the computation unit 461. Driving of the first vertical driving motor 443 is controlled by the first vertical rotation driving unit 464 based on the detection result of the first vertical angle detector 444.

The telescope part 45 is supported by the first vertical rotary shaft 441 as described above, and is rotated in the vertical direction about the first horizontal axial center 446 by a driving force transmitted from the first vertical driving motor 443. The telescope part 45 includes a collimated telescope 458, and is collimated to irradiate the target for measurement 6 with first distance measurement light 455. More specifically, the telescope part 45 includes a first distance measurement light emitting unit 451, a first distance measurement light reception unit 452, and a collimated light reception unit 453.

The first distance measurement light emitting unit 451 is controlled to be driven by the first distance measurement unit 462. The first distance measurement light emitting unit 451 is provided inside the telescope part 45, and radiates the first distance measurement light 455 such as laser light in a direction perpendicular to the first horizontal axial center 446. The first distance measurement light 455 emitted from the first distance measurement light emitting unit 451 is radiated on the target for measurement 6. First reflected distance measurement light 456 reflected by the target for measurement 6 is received by the first distance measurement light reception unit 452 provided inside the telescope part 45. The first distance measurement light reception unit 452 converts brightness/darkness (light reception result) of the received first reflected distance measurement light 456 into an electronic signal (light reception signal), and transmits the light reception signal to the first distance measurement unit 462. Furthermore, the first distance measurement light reception unit 452 receives internal reference light (not illustrated) guided from a reference light optical unit (not illustrated), converts the internal reference light into an electric signal, and transmits the electric signal to the first distance measurement unit 462.

The first distance measurement unit 462 computes a distance to the target for measurement 6 based on the light reception signal transmitted from the first distance measurement light reception unit 452. That is, the first reflected distance measurement light 456 and the internal reference light are converted into a first reflected distance measurement light electric signal and an internal reference light electric signal, respectively, and are sent to the first distance measurement unit 462. The distance to the target for measurement 6 is measured based on a difference in a time interval between the first reflected distance measurement light electric signal and the internal reference light electric signal. A computation result of the first distance measurement unit 462 is input to the computation unit (CPU) 461.

The computation unit 461 calculates a coordinate value of the target for measurement 6 based on the measured distance to the target for measurement 6, a vertical angle detected by the first vertical angle detector 444, and a horizontal angle detected by the first horizontal angle detector 434. In other words, the target for measurement 6 is installed at the known point, and therefore the computation unit 461 calculates a coordinate value of a measurement center of the collimation distance measurement unit 4 based on the measured distance to the target for measurement 6, the vertical angle detected by the first vertical angle detector 444, and the horizontal angle detected by the first horizontal angle detector 434.

The collimated light reception unit 453 is an image sensor such as a Charge Coupled Device (CCD) or a Complementary Metal Oxide Semiconductor (CMOS), and receives reflected collimated light 457 of a different wavelength range from a wavelength range of the first reflected distance measurement light 456. The reflected collimated light 457 is light that has the different wavelength range from the wavelength range of the first reflected distance measurement light 456, and is light reflected by the target for measurement 6. That is, the collimated light reception unit 453 receives the reflected collimated light 457 reflected by the target for measurement 6, and receives an image of the target for measurement 6. Examples of the reflected collimated light 457 are natural light and infrared light. In this regard, the reflected collimated light 457 is not limited to these. The reflected collimated light 457 is received by the collimated light reception unit 453 provided inside the telescope part 45. The collimated light reception unit 453 converts brightness/darkness (light reception signal) of the reflected collimated light 457 into an electronic signal (image signal), and transmits the image signal to the image processing unit 469.

The image processing unit 469 performs image processing on the image signal transmitted from the collimated light reception unit 453, and transmits the image signal as an image data signal to the computation unit 461. The computation unit 461 executes computation based on the image data signal transmitted from the image processing unit 469, and executes control of causing the display unit 471 of the operation display unit 47 to display an image of a collimation range of the telescope part 45.

The inclinometer 49 measures an inclination (inclination angle) of the collimation distance measurement unit 4 with respect to gravity. A measurement result of the inclinometer 49 is input to the computation unit 461.

The scanner unit 5 according to the present embodiment includes a second bracket part 52, a second horizontal rotation part 53, a second vertical rotation part 54, a scanning mirror 55, a second distance measurement light emitting unit 56, and a second distance measurement light reception unit 57. An external orientation element of the scanner unit 5 with respect to the collimation distance measurement unit 4 is set in advance, and known.

The second horizontal rotation part 53 includes a second horizontal rotary shaft 531, a bearing 532, a second horizontal driving motor 533, and a second horizontal angle detector 534. The second horizontal driving motor 533 is an example of a “motor” according to the present invention, and is, for example, the 3-phase brushless motor that does not include the hall sensor. The second horizontal angle detector 534 is an example of the “rotary encoder” according to the present invention, and is, for example, the rotary encoder of incremental type. The second horizontal rotary shaft 531 includes a second vertical axial center 536 that vertically extends, and is rotatably supported by the second bracket part 52 with the bearing 532 interposed therebetween. The one end part of the second horizontal rotary shaft 531 is connected to the first bracket part 42 of the collimation distance measurement unit 4. The second bracket part 52 is supported by the second horizontal rotary shaft 531, and is rotated integrally with the second horizontal rotary shaft 531 in the horizontal direction about the second vertical axial center 536 by a driving force transmitted from the second horizontal driving motor 533. The second bracket part 52 is an example of a “rotation target” according to the present invention.

The second vertical axial center 536 is parallel to the first vertical axial center 436. In the three-dimensional survey device 2 according to the present embodiment, the first vertical axial center 436 and the second vertical axial center 536 are mutually on the same straight line. In this regard, the first vertical axial center 436 and the second vertical axial center 536 are not limited to being mutually on the same straight line. A distance between the first vertical axial center 436 and the second vertical axial center 536 is known. That is, the position of the second vertical axial center 536 with respect to the first vertical axial center 436 is known.

The second horizontal angle detector 534 is provided at the other end part of the second horizontal rotary shaft 531. A rotation angle of the second horizontal rotary shaft 531 (i.e., a rotation angle of the second bracket part 52) with respect to the first bracket part 42 is detected by the second horizontal angle detector 534. A detection result of the second horizontal angle detector 534 is input to the computation unit 461. Driving of the second horizontal driving motor 533 is controlled by the second horizontal rotation driving unit 466 based on the detection result of the second horizontal angle detector 534.

The second vertical rotation part 54 includes a second vertical rotary shaft 541, a bearing 542, a second vertical driving motor 543, and a second vertical angle detector 544. The second vertical driving motor 543 is an example of the “motor” according to the present invention, and is, for example, the 3-phase brushless motor that does not include the hall sensor. The second vertical angle detector 544 is an example of the “rotary encoder” according to the present invention, and is, for example, the rotary encoder of incremental type. The second vertical rotary shaft 541 includes a second horizontal axial center 546 that horizontally extends, and is rotatably supported by the second bracket part 52 with the bearing 542 interposed therebetween. The one end part of the second vertical rotary shaft 541 protrudes in a recess part 521 of the second bracket part 52. The scanning mirror 55 is supported at the one end part of the second vertical rotary shaft 541 that protrudes in the recess part 521 of the second bracket part 52, and is rotated integrally with the second vertical rotary shaft 541 in the vertical direction about the second horizontal axial center 546 by a driving force transmitted from the second vertical driving motor 543. The scanning mirror 55 is an example of the “rotation target” according to the present invention.

The second vertical angle detector 544 is provided at the other end part of the second vertical rotary shaft 541. A rotation angle of the second vertical rotary shaft 541 (i.e., a rotation angle of the scanning mirror 55) with respect to the second bracket part 52 is detected by the second vertical angle detector 544. A detection result of the second vertical angle detector 544 is input to the computation unit 461. Driving of the second vertical driving motor 543 is controlled by the second vertical rotation driving unit 467 based on the detection result of the second vertical angle detector 544.

The second horizontal axial center 546 is parallel to the first horizontal axial center 446. A distance between the first horizontal axial center 446 and the second horizontal axial center 546 is known. That is, the position of the second horizontal axial center 546 with respect to the first horizontal axial center 446 is known.

The scanning mirror 55 is a deflection optical member, and reflects, at a right angle, second distance measurement light 565 entering from the horizontal direction. That is, the scanning mirror 55 reflects the second distance measurement light 565 entering from the horizontal direction to a direction perpendicular to the second horizontal axial center 546. The scanning mirror 55 is supported by the second vertical rotary shaft 541 as described above, and is rotated in the vertical direction about the second horizontal axial center 546 by a driving force transmitted from the second vertical driving motor 543. Thus, the scanning mirror 55 rotates and radiates the second distance measurement light 565 in a plane intersecting (more specifically, perpendicular to) the second horizontal axial center 546. Furthermore, the scanning mirror 55 reflects second reflected distance measurement light 566 reflected by a measurement target 7 and entering the scanning mirror 55 toward the second distance measurement light reception unit 57. That is, the scanning mirror 55 reflects the second reflected distance measurement light 566 reflected by the measurement target 7 and entering the scanning mirror 55 toward a direction parallel to the second horizontal axial center 546.

As illustrated in FIG. 2, the second distance measurement light emitting unit 56 includes a light emitting element 561 and a light projection optical unit 562 including an objective lens and the like, and is controlled to be driven by the second distance measurement unit 465. The light emitting element 561 is, for example, a semiconductor laser and the like, and emits the second distance measurement light 565 onto the optical axis matching with the second horizontal axial center 546 through the light projection optical unit 562. The second distance measurement light 565 is a pulse laser beam of infrared light as invisible light. The light emitting element 561 is controlled by the second distance measurement unit 465, and emits pulse light in a desired state including a desired light intensity, a desired pulse interval, and the like.

As illustrated in FIG. 2, the second distance measurement light reception unit 57 includes a light reception element 571, and a light reception optical unit 572 including a condenser lens and the like. The light reception element 571 receives the second reflected distance measurement light 566 that is obtained when the second distance measurement light 565 is reflected by the measurement target 7, and the second reflected distance measurement light 566 that has been reflected by the scanning mirror 55 and has transmitted through the light reception optical unit 572. The light reception element 571 converts brightness/darkness (light reception result) of the received second reflected distance measurement light 566 into an electronic signal (light reception signal), and transmits the light reception signal to the second distance measurement unit 465. Furthermore, the light reception element 571 receives internal reference light (not illustrated) guided from the reference light optical unit (not illustrated), converts the internal reference light into an electric signal, and transmits the electric signal to the second distance measurement unit 465.

The second distance measurement unit 465 computes a distance to the measurement target 7 based on the light reception signal transmitted from the second distance measurement light reception unit 57 (more specifically, the light reception element 571). That is, the second reflected distance measurement light 566 and the internal reference light are converted into a second reflected distance measurement light electric signal and an internal reference light electric signal, respectively, and are sent to the second distance measurement unit 465. The distance to the measurement target 7 is measured based on a difference in a time interval between the second reflected distance measurement light electric signal and the internal reference light electric signal. A computation result of the second distance measurement unit 465 is input to the computation unit 461.

The computation unit 461 calculates a coordinate value of the measurement target 7 based on the measured distance to the measurement target 7, a vertical angle detected by the second vertical angle detector 544, and a horizontal angle detected by the second horizontal angle detector 534. Furthermore, the computation unit 461 can obtain point cloud data related to an entire measurement range or point cloud data related to the measurement target 7 by recording the coordinate value of the measurement target 7 per pulse light.

In this regard, when the 3-phase brushless motor without the hall sensor is used for at least one of the first horizontal driving motor 433, the first vertical driving motor 443, the second horizontal driving motor 533, and the second vertical driving motor 543, the three-dimensional survey device 2 needs to check and store an initial phases of the phases of the motor by executing an oscillation operation of the motor, and control the motor based on the stored initial phases. However, if the three-dimensional survey device 2 executes an operation of checking and storing the initial phases of the phases of the motor during an initial operation every time, for example, the operator moves the three-dimensional survey device 2 and changes a survey spot, an operating time of the three-dimensional survey device 2 and an operating time of the operator become long. Furthermore, if the three-dimensional survey device 2 is kept powered on when, for example, the operator moves the three-dimensional survey device 2 and changes a survey spot, while it is unnecessary to check and store the initial phases of the phases of the motor every time the measurement spot is changed, power consumption of a battery of the three-dimensional survey device 2 increases.

By contrast with this, the computation unit 461 of the three-dimensional survey device 2 according to the present embodiment calculates as the initial phase the phase relationship between the phases of the motor at a zero position of the first horizontal angle detector 434, and causes the storage unit 468 to store the calculated initial phase as the driving parameter in advance. Furthermore, the computation unit 461 drives the first horizontal driving motor 433 by open loop control during the initial operation after the three-dimensional survey device 2 is powered on, and applies the driving parameter stored in the storage unit 468 as a phase angle upon detecting the zero position of the first horizontal angle detector 434. Furthermore, upon detecting the zero position of the first horizontal angle detector 434, the computation unit 461 applies the driving parameter stored in the storage unit 468 as the phase angle, and then drives the first horizontal driving motor 433 by closed loop control that uses a value of the first horizontal angle detector 434. This processing is executed similarly by the first vertical angle detector 444 and the first vertical driving motor 443, the second horizontal angle detector 534 and the second horizontal driving motor 533, and the second vertical angle detector 544 and the second vertical driving motor 543.

Hereinafter, details of an operation of the three-dimensional survey device 2 according to the present embodiment, a three-dimensional survey device driving method executed by the three-dimensional survey device 2 according to the present embodiment, and a three-dimensional survey device driving program executed by the computer of the three-dimensional survey device 2 according to the present embodiment will be described with reference to the drawings.

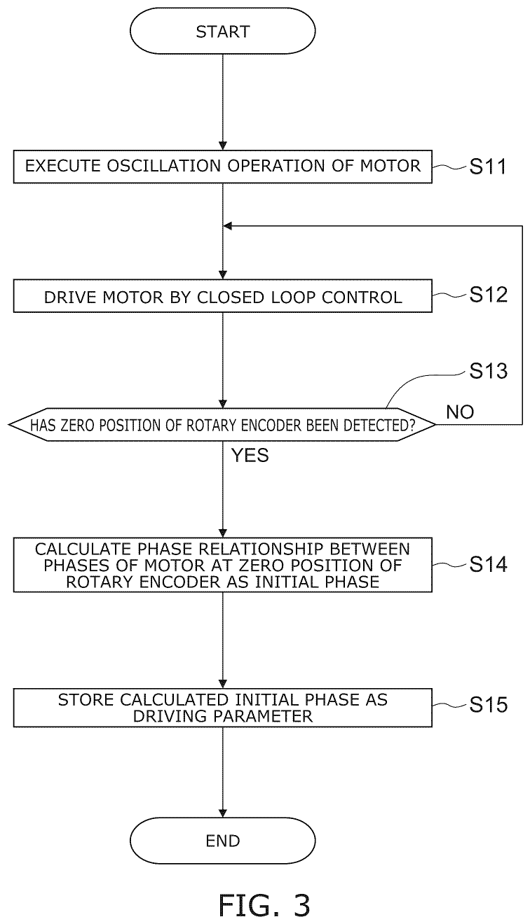

FIG. 3 is a flowchart illustrating an advance operation of the three-dimensional survey device according to the present embodiment.

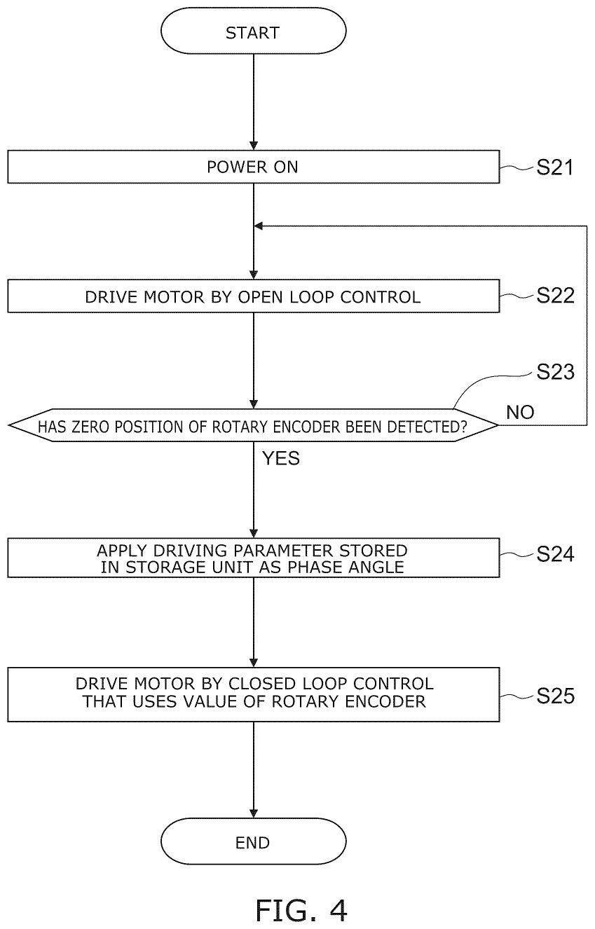

FIG. 4 is a flowchart illustrating an initial operation after the three-dimensional survey device according to the present embodiment is powered on.

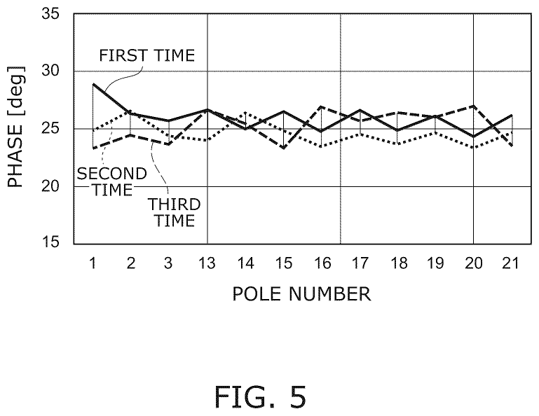

FIG. 5 is a graph illustrating an example of a measurement result of an initial phase according to the present embodiment.

Note that FIGS. 3 and 4 are the flowcharts illustrating steps executed by the three-dimensional survey device driving method according to the present embodiment, and steps that the three-dimensional survey device driving program according to the present embodiment causes the computer of the three-dimensional survey device 2 to execute.

Hereinafter, for convenience of description, the first horizontal driving motor 433, the first vertical driving motor 443, the second horizontal driving motor 533, and the second vertical driving motor 543 will be referred to as the “motors” and described, and the first horizontal angle detector 434, the first vertical angle detector 444, the second horizontal angle detector 534, and the second vertical angle detector 544 will be referred to as the “rotary encoders” and described.

First, in step S11 illustrated in FIG. 3, the three-dimensional survey device 2 executes the oscillation operation of the motor as the advance operation in, for example, a manufacturing process and an assembly process of the three-dimensional survey device 2. That is, the computation unit 461 executes control for obtaining an initial position of the motor. Next, in step S12, the computation unit 461 drives the motor by closed loop control. Next, in step S13, the computation unit 461 determines whether or not the zero position of the rotary encoder has been detected.

In a case where the zero position of the rotary encoder is not detected (step S13: NO), the computation unit 461 executes the above-described processing in step S12. On the other hand, in a case where the zero position of the rotary encoder has been detected (step S13: YES), the computation unit 461 calculates as the initial phase the initial relationship between the phases of the motor at the zero position of the rotary encoder in step S14. Next, in step S15, the computation unit 461 causes the storage unit 468 to store the calculated initial phase as the driving parameter.

In this regard, as illustrated in FIG. 5, the initial phases calculated by the computation unit 461 have variations according to the poles of the motor whose initial phases are checked by the computation unit 461. FIG. 5 illustrates an example of a result obtained by measuring a phase of a random phase (for example, the U phase of the 3-phase brushless motor) at each pole of the motor at the first time, the second time, and the third time. For example, not only the U phase of the 3-phase brushless motor, but also the V phase and the W phase also have variations of initial phases as illustrated in FIG. 5.

Hence, the computation unit 461 according to the present embodiment calculates the initial phase at each pole of the motor a plurality of times, and then causes the storage unit 468 to store an average value of the plurality of initial phases as the driving parameters. Consequently, the computation unit 461 can suppress the variations of the initial phases due to an influence of the poles of the motor when calculating the initial phases, and cause the storage unit 468 to store more stable values as driving parameters.

Thus, the advance operation in the manufacturing process and the assembly process of the three-dimensional survey device 2 are finished.

Next, in step S21 illustrated in FIG. 4, the three-dimensional survey device 2 is powered on at, for example, a survey site. Then, in step S22, the computation unit 461 drives the motor by open loop control as the initial operation after the three-dimensional survey device 2 is powered on. Next, in step S23, the computation unit 461 determines whether or not the zero position of the rotary encoder has been detected.

In a case where the zero position of the rotary encoder is not detected (step S23: NO), the computation unit 461 executes the above-described processing in step S22. On the other hand, in a case where the zero position of the rotary encoder has been detected (step S23: YES), the computation unit 461 applies the driving parameter stored in the storage unit 468 as the phase angle in step S24. Thus, the computation unit 461 according to the present embodiment does not execute the oscillation operation of the motor by closed loop control during the initial operation after power-on, and not check the initial phases of the phases of the motor. Next, in step S25, the computation unit 461 drives the motor by closed loop control that uses a value of the rotary encoder.

The three-dimensional survey device 2 according to the present embodiment does not need to perform the oscillation operation of the motor during the initial operation after being powered on, so that it is possible to reduce a time taken until the zero position of the rotary encoder is detected, and suppress the operating time. Furthermore, for example, the operator does not need to keep the three-dimensional survey device 2 powered on when moving the three-dimensional survey device 2 and changing a survey spot, and can further suppress the operating time, so that it is possible to save power consumption of the battery and increase an operable time.

Furthermore, as described above with reference to FIGS. 3 and 5, the computation unit 461 calculates the initial phase at each pole of the motor a plurality of times, and causes the storage unit 468 to store the average value of the plurality of initial phases as the driving parameter. Consequently, when calculating an initial phase, the computation unit 461 can suppress a variation of the initial phase due to an influence of the poles of the motor, and cause the storage unit 468 to store a more stable value as a driving parameter. Consequently, the three-dimensional survey device 2 can achieve more stable driving of the motor.

The embodiment of the present invention has been described above. However, the present invention is not limited to the above embodiment, and can be variously changed without departing from the claims. The configuration of the above embodiment can be partially omitted, or combined at random differently from the above.

### EXPLANATION OF REFERENCE NUMERALS

2 Three-dimensional survey device
4 Collimation distance measurement unit
5 Scanner unit
6 Target for measurement
7 Measurement target
41 Leveling part
42 First bracket part
43 First horizontal rotation part
44 First vertical rotation part
45 Telescope part
46 Control computation unit
47 Operation display unit
48 Base part
49 Inclinometer
52 Second bracket part
53 Second horizontal rotation part
54 Second vertical rotation part
55 Scanning mirror
56 Second distance measurement light emitting unit
57 Second distance measurement light reception unit
411 Adjustment screw
421 Gap part
431 First horizontal rotary shaft
432 Bearing
433 First horizontal driving motor
434 First horizontal angle detector
436 First vertical axial center
441 First vertical rotary shaft
442 Bearing
443 First vertical driving motor
444 First vertical angle detector
446 First horizontal axial center
451 First distance measurement light emitting unit
452 First distance measurement light reception unit
453 Collimated light reception unit
455 First distance measurement light
456 First reflected distance measurement light
457 Reflected collimated light
458 Collimated telescope
461 Computation unit
462 First distance measurement unit
463 First horizontal rotation driving unit
464 First vertical rotation driving unit
465 Second distance measurement unit
466 Second horizontal rotation driving unit
467 Second vertical rotation driving unit
468 Storage unit
469 Image processing unit
471 Display unit
472 Operation input unit
521 Recess part
531 Second horizontal rotary shaft
532 Bearing
533 Second horizontal driving motor
534 Second horizontal angle detector
536 Second vertical axial center
541 Second vertical rotary shaft
542 Bearing
543 Second vertical driving motor
544 Second vertical angle detector
546 Second horizontal axial center
561 Light emitting element
562 Light projection optical unit
565 Second distance measurement light
566 Second reflected distance measurement light
571 Light reception element
572 Light reception optical unit

1. A three-dimensional survey device that acquires three-dimensional data of a measurement target, the three-dimensional survey device comprising:
a motor that rotates a rotation target about an axial center;
a rotary encoder that detects a rotation angle of the rotation target;
a computation unit that calculates as an initial phase a phase relationship of a phase of the motor at a zero position of the rotary encoder; and
a storage unit that stores the initial phase calculated by the computation unit as a driving parameter,
wherein the computation unit causes the storage unit to store the driving parameter in advance, drives the motor by open loop control during an initial operation after power-on, applies the driving parameter stored in the storage unit as a phase angle upon detecting the zero position of the rotary encoder, and then drives the motor by closed loop control that uses a value of the rotary encoder.

2. The three-dimensional survey device according to claim 1, wherein the computation unit calculates the initial phase at each pole of the motor a plurality of times, and causes the storage unit to store an average value of a plurality of the initial phases as the driving parameter.

3. A three-dimensional survey device driving method for acquiring three-dimensional data of a measurement target, the three-dimensional survey device driving method comprising:
a first step of calculating as an initial phase a phase relationship of a phase of the motor at a zero position of a rotary encoder that detects a rotation angle of a rotation target;
a second step of storing the initial phase calculated in the first step as a driving parameter in a storage unit in advance;
a third step of driving the motor by open loop control during an initial operation after power-on, and applying the driving parameter stored in the storage unit as a phase angle upon detecting the zero position of the rotary encoder; and
a fourth step of driving the motor by closed loop control that uses a value of the rotary encoder.

4. A three-dimensional survey device driving program executed by a computer of a three-dimensional survey device that acquires three-dimensional data of a measurement target, the three-dimensional survey device driving program causing the computer to execute:
a first step of calculating as an initial phase a phase relationship of a phase of the motor at a zero position of a rotary encoder that detects a rotation angle of a rotation target;
a second step of storing the initial phase calculated in the first step as a driving parameter in a storage unit in advance;
a third step of driving the motor by open loop control during an initial operation after power-on, and applying the driving parameter stored in the storage unit as a phase angle upon detecting the zero position of the rotary encoder; and
a fourth step of driving the motor by closed loop control that uses a value of the rotary encoder.
